(19) United States
(12) Patent Application Publication
(10) Pub. No.: US 2019/0036719 A1
(43) Pub. Date: Jan. 31, 2019

(54) CONNECTING PHYSICAL RESOURCES TO VIRTUAL COLLABORATION MEETING

(71) Applicant: Cisco Technology, Inc., San Jose, CA (US)

(72) Inventors: Amitesh Shukla, Kanata (CA); John Parello, Campbell, CA (US)

(21) Appl. No.: 15/660,386

(22) Filed: Jul. 26, 2017

(51) Int. Cl. H04L 12/18; H04L 29/08; G06F 17/30

(52) U.S. Cl. CPC H04L 12/1818; H04L 67/125; G06F 3/0482; G06F 17/30864; G06F 17/30241

(57) ABSTRACT

In one example, a collaboration application presents a map of a geographic area that includes a network connected device. The map includes a graphical representation of the network connected device. The graphical representation has a location on the map that corresponds to a current physical location of the network connected device in the geographic area. The collaboration application receives an indication of a user selection of the graphical representation, and, in response to receiving the indication, determines that the user selection of the graphical representation corresponds to a user selection of the network connected device. The collaboration application sends, to the network connected device, an invitation to join a collaboration meeting as a peer member of the collaboration meeting.

### TECHNICAL FIELD

The present disclosure relates to connecting network connected devices to a collaboration meeting.

### BACKGROUND

The Internet of Things (IoT) is a general term used to describe the addition of networking capabilities to physical objects or “things” that serve some purpose or function outside of computing and/or networking technologies (i.e., traditionally “unconnected” or “offline” devices), such as thermometers, refrigerators, lights, wristbands, and sensors. In general, these “things,” sometimes referred to as IoT enabled-devices, IoT devices, or special purpose network connected devices, are embedded with electronics, software, and network interfaces, which enables the physical objects to send and/or receive data packets over a network.

### BRIEF DESCRIPTION OF THE DRAWINGS

FIG. 1 is an overview diagram of a collaboration environment, according to an example embodiment.

FIG. 2 is a graphical user interface of a collaboration application, according to an example embodiment.

FIG. 3 is another graphical user interface of a collaboration application, according to an example embodiment.

FIG. 4 is a mapping database, according to an example embodiment.

FIG. 5 is a diagrammatic illustration of communications between network connected devices and a collaboration application, according to an example embodiment.

FIG. 6 is a flowchart of a method for dynamically adding a network connected device to a collaboration meeting, according to an example embodiment.

FIG. 7 is a flowchart of a method for mapping network connected devices, according to an example embodiment.

FIG. 8 is a block diagram of a collaboration server configured to execute network connected device mapping techniques, according to an example embodiment.

FIG. 9 is a flowchart of a generalized method in accordance with examples presented herein.

### DESCRIPTION OF EXAMPLE EMBODIMENTS

### Overview

In one example, a collaboration application presents a map of a geographic area that includes a network connected device. The map includes a graphical representation of the network connected device. The graphical representation has a location on the map that corresponds to a current physical location of the network connected device in the geographic area. The collaboration application receives an indication of a user selection of the graphical representation, and, in response to receiving the indication, determines that the user selection of the graphical representation corresponds to a user selection of the network connected device. The collaboration application sends, to the network connected device, an invitation to join a collaboration meeting as a peer member of the collaboration meeting.

### Example Embodiments

Conventional collaboration applications may send, to human users/participants, invitations (e.g., over email) to join a collaboration meeting. These invitations may be sent via user devices (e.g., laptops, mobile phones, etc.). However, conventional collaboration applications generally cannot send invitations to network connected devices to join the collaboration meeting as peer participants of a collaboration meeting. Instead, conventionally, such devices may be included in a collaboration meeting by having a human act as a proxy for the devices.

Techniques described herein enable a collaboration application to invite a network connected device to join a collaboration meeting as a peer to a human participant. A collaboration application may dynamically add or remove peer network connected devices based on the current physical locations of the network connected devices. As will become apparent based on the following description, permitting a network connected device to join as a peer participant based on its current physical location may enhance participant experience during the collaboration meeting.

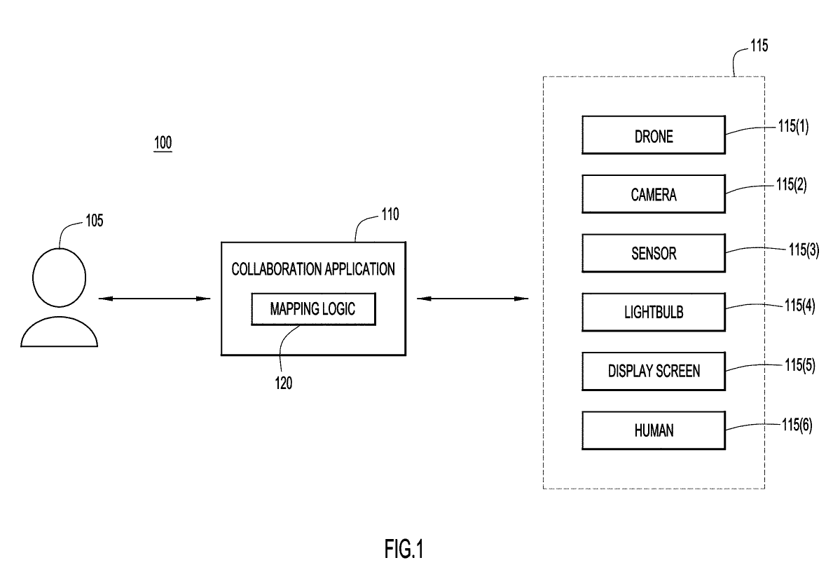

With reference made to FIG. 1, a collaboration environment 100 is shown in accordance with examples presented herein. The collaboration environment 100 includes an administrator 105, collaboration application 110, and a plurality of peer meeting participants 115. The collaboration application 110 hosts a collaboration meeting in which peer meeting participants 115 are participating. In this example, the plurality of peer meeting participants 115 includes a drone 115(1), a camera 115(2), a sensor 115(3), a lightbulb 115(4), a display screen 115(5), and a human 115(6). Peer meeting participants 115(1)-115(5) are network connected devices. The human 115(6) may be participating via another network connected device (e.g., a laptop).

The collaboration application 110 may dynamically add or remove one or more of the peer meeting participants 115 automatically or based on user input from the administrator 105. Administrator 105 may be human participant 115(6). Further, as mentioned, the collaboration application 110 may dynamically add or remove one or more of peer meeting participants 115 based on the respective current geographic locations of the peer meeting participants 115. As explained in greater detail below, collaboration application 110 includes mapping logic 120 to perform techniques described herein.

The mapping logic 120 enables one or more of the peer meeting participants 115 to connect to a collaboration meeting dynamically (e.g., without associating with a static entity or having to pass through a proxy). For example, the collaboration application 110 may send invitations to peer meeting participants 115(4)-115(6) during the scheduling, or at the start, of a collaboration meeting. The collaboration application 110 may subsequently send invitations to peer meeting participants 115(1)-115(3) after the collaboration meeting starts. In a further example, the collaboration application 110 may automatically send an invitation to a drone upon determining the drone has entered a geographic area (e.g., a conference room), and may remove the drone from the collaboration meeting upon determining the drone has exited the geographic area. Thus, in an example, the mapping logic 120 permits the collaboration application 110 to dynamically add certain network connected devices (e.g., network connected devices managed or in use by a participant, network connected devices in a certain geographical area, etc.).

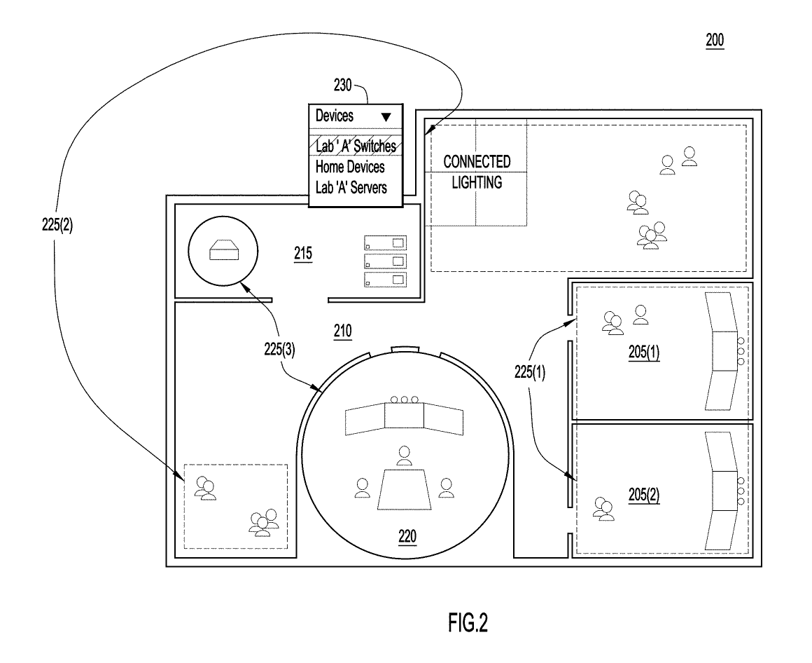

With reference to FIG. 2, shown is a graphical user interface 200 of a collaboration application in accordance with examples presented herein. A collaboration application may permit one or more human users and/or network connected devices to communicate via a virtual meeting session. The graphical user interface 200 presents a map of an indoors geographic area. The map includes two conference rooms 205(1), 205(2), an open area 210, a laboratory 215, and another conference room 220. The map also includes graphical representations of network connected devices. The graphical representations have locations on the map that correspond to current physical locations of the network connected devices in the geographic area.

FIG. 2 provides three example collaboration meetings: a first collaboration meeting represented by arrow 225(1), a second collaboration meeting represented by arrow 225(2), and a third collaboration meeting represented by arrow 225(3). As will be explained below, first and second collaboration meetings 225(1), 225(2) illustrate region selection, and the third collaboration meeting 225(3) illustrates clickable selection.

The first collaboration meeting 225(1) includes the network connected devices located in conference rooms 205(1), 205(2). A user may establish the first collaboration meeting 225(1) by selecting (e.g., dragging a cursor over) the region spanning the graphical representation of the conference rooms 205(1), 205(2). In response, the collaboration application determines that the user selection of the graphical representation of the network connected devices located in the graphical representations of conference rooms 205(1), 205(2) corresponds to a user selection of the network connected devices located in conference rooms 205(1), 205(2). The collaboration application sends, to the network connected devices, an invitation to join the first collaboration 225(1) meeting as peer members. Thus, the network connected devices in conference rooms 205(1), 205(2) (e.g., telepresence units, microphones, etc.) dynamically join the first collaboration meeting 225(1). This allows conference rooms 205(1), 205(2) to be utilized for a single collaboration meeting.

The second collaboration meeting 225(2) includes network connected devices located in select, physically separate regions of open area 210. In this example, a celebration is occurring in open area 210. A user (e.g., administrator, meeting participant, etc.) who is authorized to handle the network connected devices in the open area 210 may establish the second collaboration meeting 225(2) by selecting (e.g., dragging a cursor over) the select regions of the graphical representation of the open area 210. Optionally, the user may first select “connected lighting” in a drop-down menu (not shown) in order to filter, from the map, network connected devices that are not connected lighting devices. The user selects (e.g., by dragging a cursor over and/or clicking) the region spanning the graphical representation of the open area.

The collaboration application determines that the user selection of the graphical representation of the network connected devices (e.g., connected lighting) located in the select regions of the graphical representations of open area 210 corresponds to a user selection of the network connected devices located in the select regions of the open area 210. In response, the collaboration application sends, to the network connected devices, an invitation to join the second collaboration meeting 225(2) as peer members. Thus, the network connected devices in the select regions of the open area 210 (e.g., connected lighting) dynamically join the second collaboration meeting 225(2). This allows the connected lighting to be utilized for the celebration. For instance, the user may select a predefined connected lighting setting (e.g., “birthday”) to cause the connected lighting to provide a celebratory ambience.

A user may wish to cause a specific, individually owned network device (e.g., drone, router, etc.) to join a collaboration meeting for debugging purposes. For example, in the third collaboration meeting 225(3), a user wishes for a switch located in laboratory 215 to join the third collaboration meeting 225(3). The drop-down menu 230 may only display devices/categories of devices that the user is authorized to access. Optionally, the user may first select “Lab ‘A’ Switches” in drop-down menu 230 in order to filter, from the map, network connected devices that are not switches located in Lab ‘A’ (e.g., Lab ‘A’ Servers). The third collaboration meeting 225(3) occurs at least partly in conference room 220. The user may cause the switch to join the third collaboration meeting 225(3) by selecting (e.g., clicking) the graphical representation of the switch. The collaboration application determines that the user selection of the graphical representation of the switch corresponds to a user selection of the switch. In response, the collaboration application sends, to the switch, an invitation to join the third collaboration meeting 225(3) as a peer member. Thus, the switch dynamically joins the third collaboration meeting 225(3). This allows the user to, for example, address debugging issues in collaboration with others.

Each network connected device displayed on the map may have an associated Uniform Resource Identifier (URI). For example, a light (light “22”) in an open area (open area “3”) in a building (building “9”) in a geographic location (“SJ”) may have the URI SJ/9/OA3/L22. The URI SJ/9/OA3 may correspond to all devices (e.g., including light 22) in open area 3. Open area 3 may be, for example, open area 210 as illustrated in FIG. 2. Such URIs are addresses to which meeting invitations may be sent.

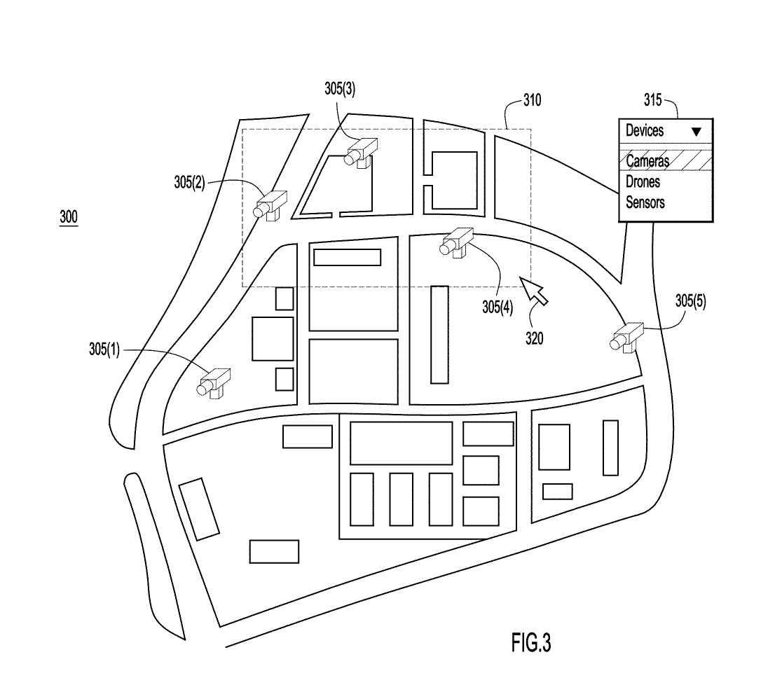

With reference to FIG. 3, shown is another graphical user interface 300 of a collaboration application in accordance with examples presented herein. The graphical user interface 300 presents a map of an outdoor geographic area. The map is a graphical representation of a campus that includes security cameras. The map includes graphical representations 305(1)-305(5) of the cameras. The locations of the graphical representations 305(1)-305(5) of the security cameras on the map correspond to the physical locations of the cameras in the campus.

FIG. 3 provides an example collaboration meeting involving a campus security team. During the course of a meeting, a user (e.g., a member of the campus security team) may wish to view security footage from cameras corresponding to graphical representations 305(2)-305(4) because they are located in a specific region of interest 310. Optionally, a drop-down menu 315 may present, to the user, categories of network connected devices. The category “Cameras” includes the cameras in the region of interest 310, for example. The user may select “Cameras” from the drop-down menu 315. This causes the collaboration application to update the map to display the graphical representations 305(1)-305(5). For example, selecting “Cameras” may cause the map to begin displaying graphical representations of security cameras, or to cease displaying graphical representations that are not graphical representations of security cameras. The map may update to display only the graphical representations 305(1)-305(5) that the user is authorized to select.

Once the user has selected the “Cameras” category from the drop-down menu 315, the user may select the region 310 by, for example, dragging a cursor 320 over the region 310. The collaboration application determines that the user selection of the graphical representation of the cameras 305(2)-305(4) corresponds to a user selection of the security cameras located in the corresponding region of campus. In response, the collaboration application sends, to the cameras 305(2)-305(4), an invitation to join the collaboration meeting as peer members. This allows the user to, for example, view security footage from the selected cameras. It will be understood that similar use cases may exist for selecting drones, connected vehicles, sensors, etc. For example, the collaboration application may allow for real-time sensor monitoring to assess a situation at a site/location during an emergency collaboration meeting. In this example, sensors may be dynamically added or removed to assess different sites.

The user may alternatively select the region of interest 310 before engaging the drop-down menu 315. In this example, the drop-down menu 315 may list only categories of devices that are currently located in the region of interest 310. For example, if there are no drones currently located in the region of interest 310, the drop-down menu 315 may not display “drones” as a category. Thus, the drop-down menu 315 may dynamically update based on the current geographical location of the network connected devices in the region of interest 310. The drop-down menu 315 may only display devices/categories of devices that a user is authorized to access.

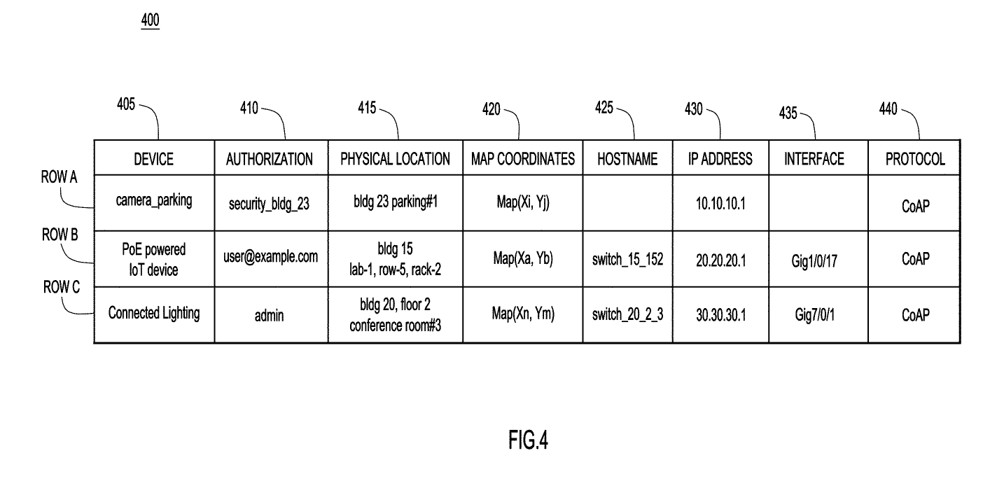

As previously mentioned, a collaboration application (e.g., as described in connection with FIGS. 1-3) may determine that a user selection of a graphical representation corresponds to a user selection of a network connected device. To make this determination, a collaboration application may maintain a mapping database that correlates the physical location and the graphical representation of the network connected device. An example mapping database 400 is shown in FIG. 4. The mapping database 400 includes a device field 405, an authorization field 410, a physical location field 415, a map coordinates field 420, a hostname field 425, an Internet Protocol (IP) address field 430, an interface field 435, and a protocol field 440.

The device field 405 provides information relating to the type of network connected device. For example, “camera_parking” in Row A of the mapping database 400 may refer to a security camera in the region of interest in FIG. 3. The authorization field 410 provides information relating to the human(s) who are authorized to configure/use/invite the corresponding network connected device. For example, the authorization field 410 in Row A may indicate that any member of the security team for building 23 is authorized to send an invitation to the camera.

The physical location field 415 indicates the physical location of the corresponding network connected device. For example, the physical location of the camera is parking lot 1 of building 23. The physical location field 415 may dynamically update based on the current physical location of the network connected devices. This may involve the collaboration application determining a subsequent physical location of a network connected device in a geographic area. For instance, the physical location of a drone may change because drones are mobile network connected devices. Thus, if the mapping table 400 were to include information relating to a drone, the physical location field 415 for the drone would update/change dynamically (e.g., periodically, in response to a stimulus/message/notification, etc.). Fixed devices (e.g., security camera 305(4)) may not change physical locations, and therefore the physical location field 415 for such devices may not dynamically update.

The map coordinates field 420 indicates the location of the graphical representation of a network connected device on the map. This location corresponds to the physical location of the network connected device. In the example of Row A, the map coordinates {Xᵢ, Yⱼ} may correspond to parking lot 1 of building 23 as graphically represented on the map of FIG. 3. The collaboration application may consult the mapping database 400 to determine that the location of the graphical representation of the network device (e.g., the map coordinates field 420) is correlated with the network connected device (e.g., the device field 405). For example, if a user clicks on the graphical representation (or drags over an area that includes the graphical representation), the collaboration application may determine that the user selection of the graphical representation corresponds to a user selection of the network connected device. Thus, the collaboration application may query the mapping database 405 for fixed devices (e.g., pre-built into the mapping database 405) and/or mobile devices.

Like the physical location field 415, the map coordinates field 420 may dynamically update. In one example, the collaboration application dynamically updates the mapping database 400 to correlate a network connected device with a subsequent physical location of the network connected device and a subsequent location of the graphical representation that corresponds to the subsequent physical location. For instance, if the physical location field 415 for a drone changes/updates, the map coordinates field 420 for the drone may dynamically update accordingly. The collaboration application may dynamically update the map based on the mapping database 400. This may permit the user to dynamically add or remove network connected devices from the collaboration meeting even if the network connected devices change location.

The hostname field 425 indicates the host name of the corresponding network connected device. As illustrated by Row A, certain network connected devices may not have a specified host name. The IP address field 430 indicates the IP address of the corresponding network connected device. For instance, the IP address of the camera is 10.10.10.1. The interface field 435 indicates the type of interface associated with the corresponding network connected device. Like the hostname field 425, certain network connected devices may not have a specified type of interface. The protocol field 440 indicates the particular protocol(s) by which the collaboration application communicates with the corresponding network connected device. In this example, the security camera uses the Constrained Application Protocol (CoAP) as described in Internet Engineering Task Force (IETF) Request for Comments (RFC) 7252.

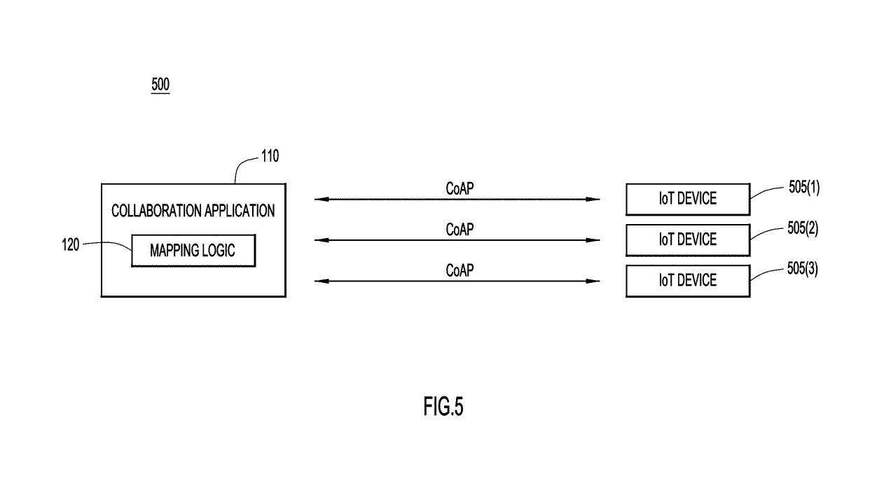

FIG. 5 is a diagrammatic illustration 500 of example communications between network connected devices 505(1)-505(3) and collaboration application 110. In this example, the collaboration application 110 communicates with the network connected devices 505(1)-505(3) via CoAP (e.g., CoAP observe). For example, the network connected devices 505(1)-505(3) may register with the collaboration application 110 using CoAP before the start of the collaboration meeting. During meeting scheduling, the host/user may register network connected devices 505(1)-505(3), which in this example are required for the collaboration meeting. Thus, the collaboration application 110 may determine the current physical location of a network connected device in a geographic area (e.g., via CoAP) before the meeting begins and construct the mapping database 400 to include the physical location field 415. The collaboration application 110 may present the map to a user based on the mapping database 400. The map permits a user to, for example, invite specified network connected devices to a scheduled or ongoing collaboration meeting. The user may invite network connected devices based on geography and/or association (e.g., mobile phones, user-owned network connected devices, etc.). In one example, the collaboration application 110 may send commands/notifications (e.g., commands with predefined instructions) to network connected devices 505(1)-505(3). The meeting participants may receive (e.g., via email) a control mechanism to override any such command or apply a new/different command.

When the collaboration meeting begins, the collaboration application 110 may send a CoAP command/notification to network connected devices 505(1)-505(3) (e.g., telepresence units, connected lighting, sensors, etc.). The command/notification may prompt network connected devices 505(1)-505(3) to join the meeting automatically and perform predefined actions. For example, a security camera or drone may begin streaming video to the collaboration application when the collaboration meeting begins.

After the collaboration meeting begins, the collaboration application 110 may enable manual or automatic dynamic addition or removal of one or more network connected devices to/from the collaboration meeting. A user may invite/control, e.g., connected lighting, thermostats, cameras, etc. For example, connected lighting may be invited to a collaboration meeting and set to a festive setting during a celebration. In addition, sub-groups of network connected devices may be specified. For example, a sub-group may include a drone and a particular display in a meeting room. In this example, the drone may dynamically stream video solely on the particular display dynamically, while other displays in the meeting room may be used for other purposes (e.g., a presentation of the meeting). In another example, data from multiple sensors in a sub-group may be presented side-by-side in real-time during a collaboration meeting.

The above example involving sensors enables the dynamic grouping of sensors based on physical location and the dynamic creation of different groups to achieve different results. These sensors, or groups of sensors, may be added to a collaboration meeting. Dynamic grouping may be based on, for example, site location, threshold bundles, faulty sensor bundles, or any other well-defined parameters. In a further example, the collaboration application maps the sensors as well as other network connected devices (e.g., devices on the Internet), so that two groups may be dynamically added during a meeting. For example, one group may bundle temperature sensors at a particular site and another group may include the heating, ventilation, and air conditioning (HVAC) system on the same site. With both groups joining the ongoing meeting, it is possible to assess the situation at the site and take corresponding action in parallel. Based on the sensor group monitoring the HVAC system group, the HVAC systems may be controlled to achieve a desired result. Feedback on this result may be provided immediately by the sensor bundle. It will be appreciated that sensor monitoring is just one example use case.

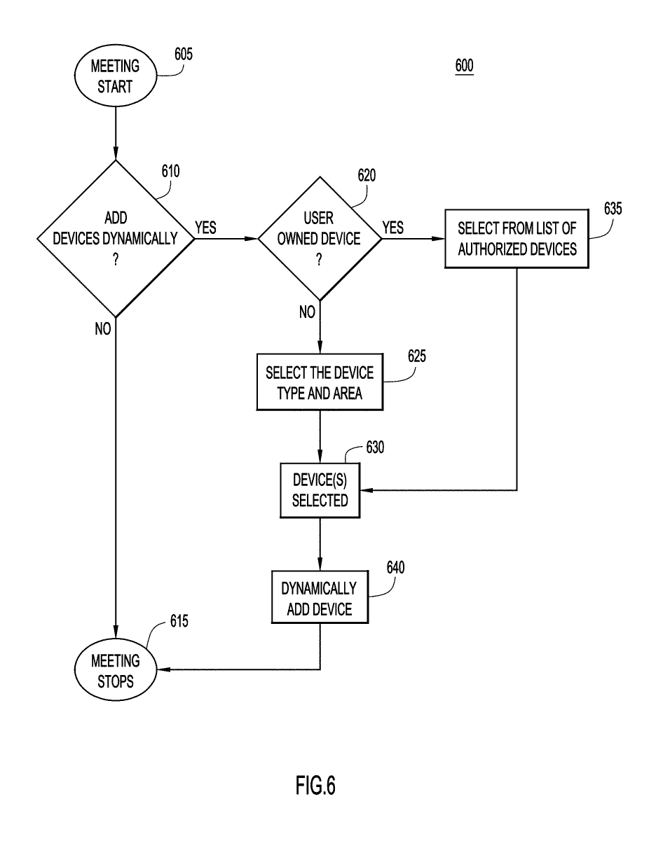

FIG. 6 is a flowchart 600 of an example method for dynamically adding a network connected device to a collaboration meeting. At 605, the collaboration meeting starts. At 610, it is determined whether a network connected device is to be dynamically added to the collaboration meeting. If not, the collaboration meeting proceeds without sending an invitation to the network connected device until the meeting has concluded at 615. If network connected device is to be dynamically added to the collaboration meeting, the flow proceeds to 620.

At 620, it is determined whether the network connected device is user owned. If the network connected device is not user owned, at 625 the user may select a device type (e.g., from a drop-down menu) and area/region on the map. At 630, the collaboration application selects the network connected device (e.g., using a mapping database). If the network connected device is user owned, at 635 the network connected device may be manually or automatically selected from a list of authorized devices. The flow may proceed to 630 where, as mentioned, the collaboration application selects the network connected device/registers the network connected device as selected. At 640, the collaboration application dynamically adds (e.g., sends an invitation to) a network connected device to the collaboration meeting. The flow proceeds to 615, where the collaboration meeting stops.

While the method of FIG. 6 is dynamic (i.e., applied during an ongoing meeting), it will be understood that similar techniques may apply before the collaboration meeting begins (e.g., during collaboration meeting scheduling). For example, a collaboration application may, at the start of the collaboration meeting, send invitations to network connected devices that a user registered/selected before the collaboration meeting started.

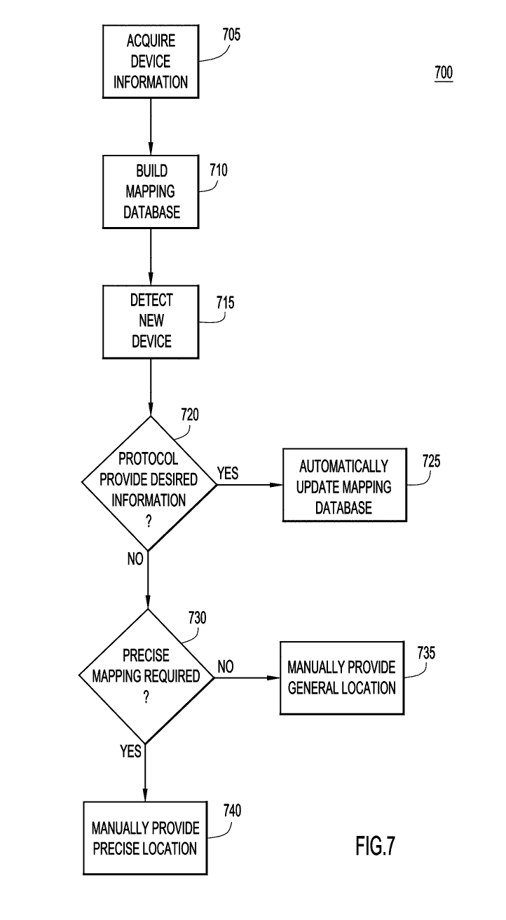

FIG. 7 is a flowchart 700 of an example method for mapping network connected devices. At 705, the collaboration application acquires information (e.g., location information, authorization information, IP address, etc.) regarding the network connected devices. The collaboration application may communicate with the network connected devices using, for example, CoAP, H.325, Ethernet protocols, protocols for cloud based applications, etc. The collaboration application may also determine whether the device is to be added or removed from a collaboration meeting.

At 710, the collaboration application builds a mapping database based on the acquired information. The mapping database (e.g., mapping database 400) may include information of a well-defined area in a building floor that is mapped to the appropriate mapping coordinates. For example, a conference room may have a range in the map from {Xᵢ, Yᵢ} to {Xₙ, Yₙ}. The mapping table may include map coordinates {Xₖ, Yₖ} for a graphical representation of a network connected device that correspond to the physical location of the network connected device in the conference room. The mapping database may include manually input information (e.g., for certain fixed devices) and/or automatically discovered information (e.g., for certain mobile devices). For example, the mapping database may include manually input information for a security camera, as well as information automatically obtained from a connected vehicle (e.g., via a global positioning system).

At 715, the collaboration application detects a new network connected device. For example, a mobile device, such as a drone, may have recently entered a region of interest. The collaboration application may tag the network connected device as unidentified and display a corresponding graphical representation on the map. The collaboration application may also/alternatively send a notification to a user/administrator about the new network connected device.

At 720, it is determined whether the protocol (e.g., CoAP) used to communicate with the device provides the desired information (e.g., information to populate the mapping database). If the protocol is sufficiently intelligent to permit communication of the desired information (e.g., network connected device location and authorization information), the collaboration application may automatically update the mapping database (e.g., with updated map coordinates, physical location, etc.) at 725. External protocols may provide other information, such as IP address, interface, port, and other desired information. The mapping database may also maintain this other information.

If the protocol does not provide the desired information, the flow proceeds to 730, where it is determined whether precise mapping is required. If precise mapping is not required, the user/administrator may manually provide general location information and authorization details at 735. For example, the user may manually input Conf_Room_1 as the physical location and all_employees as the authorization information. The collaboration application may automatically allocate the next available map coordinates from the predefined range corresponding to conference room 1. Thus, the mapping database may be updated to include the desired information. External protocols may provide other information, such as IP address, interface, port, and other desired information. The mapping database may also maintain this other information. If precise mapping is required, the user/administrator may manually provide precise location information and authorization details at 740. For example, the user may manually provide a precise location and input admin_to_vp as the authorization information.

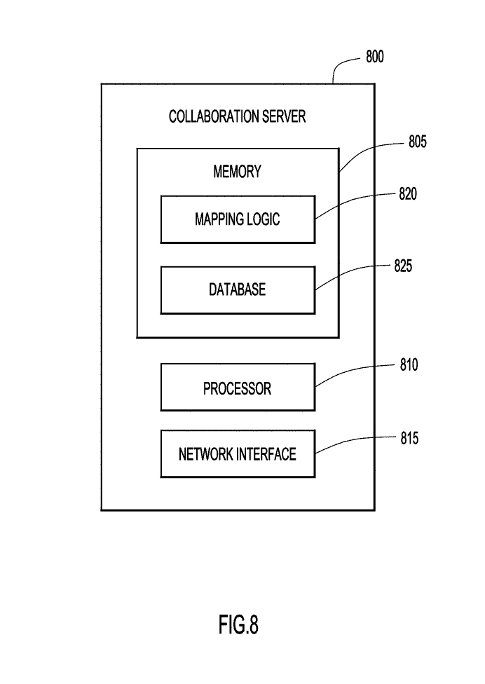

FIG. 8 is a block diagram of a collaboration server 800 that is configured to implement techniques presented herein. In this example, the collaboration server 800 includes a memory 805, one or more processors 810, and a network interface 815. The memory 805 includes mapping logic 820 (e.g., mapping logic 120 of FIG. 1) and a database 825 (e.g., mapping database 400 of FIG. 4). The one or more processors 810 are configured to execute instructions stored in the memory 805 (e.g., mapping logic 820). When executed by the one or more processors 810, the mapping logic 820 enables the collaboration server 800 to perform the operations associated with techniques described herein.

The memory 805 may be read only memory (ROM), random access memory (RAM), magnetic disk storage media devices, optical storage media devices, flash memory devices, electrical, optical, or other physical/tangible memory storage devices. Thus, in general, the memory 805 may comprise one or more tangible (non-transitory) computer readable storage media (e.g., a memory device) encoded with software comprising computer executable instructions and when the software is executed (by the processor 810) it is operable to perform the operations described herein.

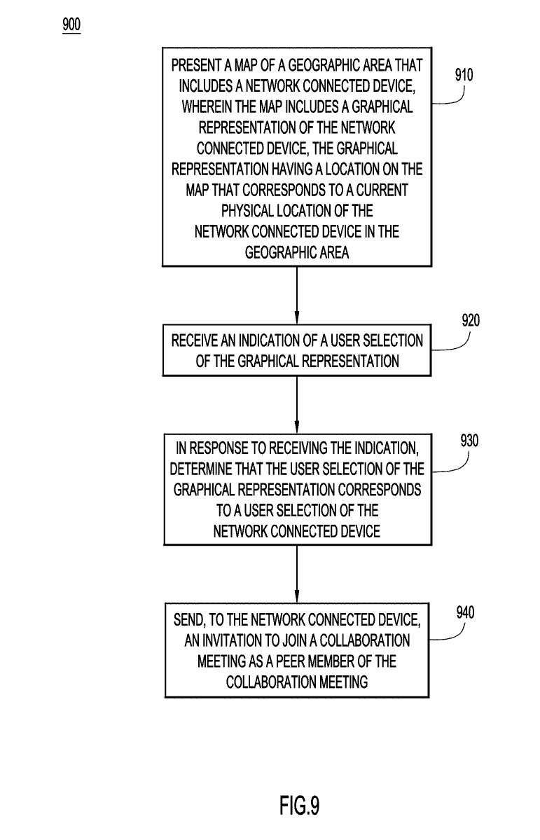

FIG. 9 is a flowchart 900 of a generalized method in accordance with examples presented herein. At 910, a collaboration application presents a map of a geographic area that includes a network connected device, wherein the map includes a graphical representation of the network connected device, the graphical representation having a location on the map that corresponds to a current physical location of the network connected device in the geographic area. At 920, the collaboration application receives an indication of a user selection of the graphical representation. At 930, in response to receiving the indication, the collaboration application determines that the user selection of the graphical representation corresponds to a user selection of the network connected device. At 940, the collaboration application sends, to the network connected device, an invitation to join a collaboration meeting as a peer member of the collaboration meeting.

A collaboration application may invite physical network connected devices to a collaboration meeting on a per-meeting basis. This enables the creation of an accurate communication path between the collaboration application and the physical network connected devices. Physical network connected devices may be dynamically added or removed from a meeting instance across geographical locations, connected directly or logically (e.g., over the Internet). Different groups/sub-groups of network connected devices may be created for a meeting depending on the specific need. These techniques may enhance existing collaboration tools, and may provide ease of customer use for network connected devices (e.g., connected lighting, sensors, etc.) during a conference. This is a useful and convenient interface for communicating with network connected devices. During fun events, the collaboration application described herein may create a suitable ambiance (e.g., via connected lighting). A user no longer is required to be tethered to a network connected device during a collaboration meeting.

In addition to dynamically adding individual network connected devices, the collaboration application may select multiple network connected devices without knowing the identities of the network connected devices. For example, in a security team meeting, the participants may assess any situation in a particular area despite not knowing the individual identities (e.g., IP address, etc.) of security cameras. Thus, the collaboration application does not require prior knowledge of the identity of the network connected device to be dynamically added to the collaboration session.

The physical location of network connected devices may be an important aspect of the collaboration meeting. Logically mapping network connected devices by, e.g., map coordinate pixels, IP address, physical location, authorization, etc. allows network connected devices to be dynamically added based purely on physical location. This eliminates the need for any new hardware controller or new wiring connections. For example, by selecting smart ceiling lights in different physical locations, the collaboration application may bring those lights under the direct control of a user/participant in the collaboration meeting. Whereas most conventional systems involve a centralized controller to controls only local devices, the collaboration application connects network connected devices that are located at a different locations and that are not necessarily connected directly to the local central controller device.

In addition, current systems cannot add devices to a meeting on an ownership basis. The techniques described herein allow for access based on “authorization”. The mapping database illustrates how an individual network connected device may join a meeting session based on authorization. During a virtual collaboration session, a participant can privately or publicly connect to a particular device and provide additional input during the meeting. For example, during a virtual meeting, participants may monitor their individually owned drones and provide additional input or make the streaming available to other participants. Another use case involves monitoring or controlling devices at home (e.g., personal network connected devices) from within the meeting interface. This allows a user to, for example, respond to an emergency situation from within the meeting.

Also described is the dynamic grouping/sub-grouping of network connected devices based on a requirement during a collaboration session. The group/sub-group may be made part of an ongoing session. Different groups of devices may be formed based on physical location, authorized access, personal network connected devices, etc. to achieve different results by dynamically adding the network connected devices while the collaboration session is active. The mapping system provides a logical way of forming groups of similar or different devices. This may be achieved via the mapping database, e.g., if physical location is important. Alternatively, the network connected devices may be classified and bundled together dynamically based on other factors, such as a well-defined threshold (e.g., all sensors above a certain temperature threshold, connected cars travelling over a specified speed limit, etc.) or an event.

The collaboration application controls network connected devices in the context of a meeting instance rather than in the context of a particular room. The graphical user interface described herein is software based and accessible to every participant via a network connected device (e.g., laptops, mobile phones, etc.) In addition, the collaboration application may populate different network connected devices based on which network connected devices the participants are authorized to access rather than fixed set of devices tied to the central controller. The collaboration application may also provide access to the personal network connected devices during the meeting. In addition, these techniques are consistent with certain advertisement schemes.

As mentioned, the collaboration application logically maps physical network connected devices (e.g., devices close to or in use by a user). This enables, for example, mapping sensors to an ongoing meeting and monitoring real time values to assess a situation in the field. The collaboration application may also provide the capability to dynamically add or remove network connected devices from a collaboration meeting that is not necessarily connected directly to the collaboration application. In one example, the physical devices may be associated with virtual collaboration instances. Logical sub-groups of devices may be dynamically created for different collaboration instances. The devices may be controlled or monitored using any underlying communication protocol. For example, the collaboration application may have complete knowledge of smart ceiling lights that are joined to a particular meeting instance, which can be controlled from a meeting tool interface.

Due to the complete logical mapping and knowledge of physical network connected devices (e.g., connected smart lighting, sensors, display screen, etc.), reserved rooms, etc., many variants of logical grouping may be created dynamically. Complete knowledge of the devices permits various sub-groups of the devices to be created and controlled even if the devices are physically separated.

A user interface is also provided for on-boarding and selecting devices dynamically. Various mappings are possible to achieve different results. For example, any of the following features may be mapped to each other (e.g., in a mapping database): the network connected device; the user/owner; the physical location; the network interface; the meeting instance; etc. Different combinations may be mapped/utilized in a meeting to achieve different results. For example, device-to-device mapping may permit a drone to be dynamically mapped to specified display screens during a meeting so that the drone streams the video directly to the specified display screens.

In one form, a method is provided. The method comprises: presenting a map of a geographic area that includes a network connected device, wherein the map includes a graphical representation of the network connected device, the graphical representation having a location on the map that corresponds to a current physical location of the network connected device in the geographic area; receiving an indication of a user selection of the graphical representation; in response to receiving the indication, determining that the user selection of the graphical representation corresponds to a user selection of the network connected device; and sending, to the network connected device, an invitation to join a collaboration meeting as a peer member of the collaboration meeting.

In another form, an apparatus is provided. The apparatus comprises: a network interface configured to communicate with a network connected device; a memory; and one or more processors coupled to the memory, wherein the one or more processors are configured to: present a map of a geographic area that includes the network connected device, wherein the map includes a graphical representation of the network connected device, the graphical representation having a location on the map that corresponds to a current physical location of the network connected device in the geographic area; receive an indication of a user selection of the graphical representation; in response to receiving the indication, determine that the user selection of the graphical representation corresponds to a user selection of the network connected device; and send, to the network connected device, an invitation to join a collaboration meeting as a peer member of the collaboration meeting.

In another form, one or more non-transitory computer readable storage media are provided. The non-transitory computer readable storage media are encoded with instructions that, when executed by a processor, cause the processor to: present a map of a geographic area that includes a network connected device, wherein the map includes a graphical representation of the network connected device, the graphical representation having a location on the map that corresponds to a current physical location of the network connected device in the geographic area; receive an indication of a user selection of the graphical representation; in response to receiving the indication, determine that the user selection of the graphical representation corresponds to a user selection of the network connected device; and send, to the network connected device, an invitation to join a collaboration meeting as a peer member of the collaboration meeting.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
presenting a map of a geographic area that includes a network connected device, wherein the map includes a graphical representation of the network connected device, the graphical representation having a location on the map that corresponds to a current physical location of the network connected device in the geographic area;
receiving an indication of a user selection of the graphical representation;
in response to receiving the indication, determining that the user selection of the graphical representation corresponds to a user selection of the network connected device; and
sending, to the network connected device, an invitation to join a collaboration meeting as a peer member of the collaboration meeting.

2. The method of claim 1, further comprising:
maintaining a database that correlates the location of the graphical representation and the network connected device.

3. The method of claim 2, wherein determining that the user selection of the graphical representation corresponds to the user selection of the network connected device includes:
consulting the database to determine that the location of the graphical representation is correlated with the network connected device.

4. The method of claim 2, further comprising:
determining the current physical location of a network connected device in a geographic area; and
constructing the database, wherein the database further includes the current physical location of the network connected device, and wherein
presenting the map includes presenting the map based on the database.

5. The method of claim 2, further comprising:
determining a subsequent physical location of the network connected device in the geographical area;
dynamically updating the database to correlate the network connected device with the subsequent physical location of the network connected device and a subsequent location of the graphical representation that corresponds to the subsequent physical location; and
dynamically updating the map based on the database.

6. The method of claim 1, further comprising:
presenting, to the user, categories of network connected devices, wherein the network connected devices include the network connected device;
receiving, from the user, an indication of a selection of a category of the categories of the network connected devices; and
updating the map to display respective graphical representations of the network connected devices of the category.

7. The method of claim 6, wherein updating the map to display the respective graphical representations includes:
updating the map to display only respective graphical representations of network connected devices for which the user is authorized to select.

8. The method of claim 1, wherein receiving the indication of the user selection of the graphical representation includes:
receiving an indication of a selection of a region of the map, wherein the region includes the location of the graphical representation.

9. The method of claim 1, further comprising:
logically grouping the network connected device into a group including at least one other network connected device.

10. An apparatus comprising:
a network interface configured to communicate with a network connected device;
a memory; and
one or more processors coupled to the memory, wherein the one or more processors are configured to:
present a map of a geographic area that includes the network connected device, wherein the map includes a graphical representation of the network connected device, the graphical representation having a location on the map that corresponds to a current physical location of the network connected device in the geographic area;
receive an indication of a user selection of the graphical representation;
in response to receiving the indication, determine that the user selection of the graphical representation corresponds to a user selection of the network connected device; and
send, to the network connected device, an invitation to join a collaboration meeting as a peer member of the collaboration meeting.

11. The apparatus of claim 10, wherein the one or more processors are further configured to:
maintain a database that correlates the location of the graphical representation and the network connected device.

12. The apparatus of claim 11, wherein the one or more processors are configured to determine that the user selection of the graphical representation corresponds to the user selection of the network connected device by:
consulting the database to determine that the location of the graphical representation is correlated with the network connected device.

13. The apparatus of claim 11, wherein the one or more processors are further configured to:
determine the current physical location of a network connected device in a geographic area; and
construct the database, wherein the database further includes the current physical location of the network connected device, and wherein the one or more processors are further configured to:
present the map by presenting the map based on the database.

14. The apparatus of claim 11, wherein the one or more processors are further configured to:
determine a subsequent physical location of the network connected device in the geographical area;
dynamically update the database to correlate the network connected device with the subsequent physical location of the network connected device and a subsequent location of the graphical representation that corresponds to the subsequent physical location; and
dynamically update the map based on the database.

15. The apparatus of claim 10, wherein the one or more processors are further configured to:
present, to the user, categories of network connected devices, wherein the network connected devices include the network connected device;
receive, from the user, an indication of a selection of a category of the categories of the network connected devices; and
update the map to display respective graphical representations of the network connected devices of the category.

16. One or more non-transitory computer readable storage media encoded with instructions that, when executed by a processor, cause the processor to:
present a map of a geographic area that includes a network connected device, wherein the map includes a graphical representation of the network connected device, the graphical representation having a location on the map that corresponds to a current physical location of the network connected device in the geographic area;
receive an indication of a user selection of the graphical representation;
in response to receiving the indication, determine that the user selection of the graphical representation corresponds to a user selection of the network connected device; and
send, to the network connected device, an invitation to join a collaboration meeting as a peer member of the collaboration meeting.

17. The non-transitory computer readable storage media of claim 16, wherein the instructions further cause the processor to:
maintain a database that correlates the location of the graphical representation and the network connected device.

18. The non-transitory computer readable storage media of claim 17, wherein the instructions that cause the processor to determine that the user selection of the graphical representation corresponds to the user selection of the network connected device include:
instructions that cause the processor to consult the database to determine that the location of the graphical representation is correlated with the network connected device.

19. The non-transitory computer readable storage media of claim 17, wherein the instructions further cause the processor to:
determine the current physical location of a network connected device in a geographic area; and
construct the database, wherein the database further includes the current physical location of the network connected device, and wherein the instructions that cause the processor to:
present the map include instructions that cause the processor to present the map based on the database.

20. The non-transitory computer readable storage media of claim 17, wherein the instructions further cause the processor to:
determine a subsequent physical location of the network connected device in the geographical area;
dynamically update the database to correlate the network connected device with the subsequent physical location of the network connected device and a subsequent location of the graphical representation that corresponds to the subsequent physical location; and
dynamically update the map based on the database.
